(19) United States
(12) Patent Application Publication
(10) Pub. No.: US 2007/0198491 A1
(43) Pub. Date: Aug. 23, 2007

(54) SYSTEM AND METHOD FOR SEARCHING AND FILTERING WEB PAGES

(75) Inventors: Liang-Pu Li, Shenzhen (CN); Chung-I Lee, Tu-Cheng (TW); Chien-Fa Yeh, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/614,988

(22) Filed: Dec. 22, 2006

(30) Foreign Application Priority Data
Feb. 10, 2006 (CN) 200610033575.9

(51) Int. Cl. G06F 17/30

(52) U.S. Cl. 707/3

(57) ABSTRACT

A method for searching and filtering Web pages is provided. The method includes the steps of: generating connection commands according to a search string transmitted from a client computer (50); generating a hyperlink list by executing the connection commands; generating extraction commands; extracting integrated links related to the search string in each hyperlink in the hyperlink list by executing the extraction commands; determining whether the extracted integrated links exist in a database (20) according to titles of the integrated links; deleting the integrated links that already exist in the database; downloading Web pages of the integrated links that do not exist in the database; determining whether there are any information irrelevant to the search string in the downloaded Web pages; and filtering out the information which are irrelevant to the search string. A related system is also disclosed.

### BACKGROUND OF THE INVENTION

1. Field of the Invention

The present invention generally relates to systems and methods for information searching, and more particularly to a system and method for searching and filtering Web pages.

2. Description of related art

The advent of global computer networks, such as the Internet, has led to entirely new and different ways to obtain information. A user on the Internet can now access information from anywhere in the world, with no regard for the actual location of either the user or the information. A user can obtain information simply by knowing a network address for the information and providing the address to an appropriate application program such as a search engine.

Generally, a website releases information by listing titles and corresponding hyperlinks of the released information. When a user search desired information, he/she inputs the network address of the information through a search engine, and then the search engine provides a list of tiles and corresponding hyperlinks. When the user clicks a hyperlink of the information, a plurality of Web pages may be displayed before the user. In these Web pages, there are many contents including advertisements and other irrelevant information, which can disturb the user.

What is needed, therefore, is a system and method for searching and filtering Web pages that can automatically filter irrelevant contents in Web pages, so as to improve precision of searching desired information.

### SUMMARY OF THE INVENTION

A system for searching and filtering Web pages in accordance with a preferred embodiment includes at least one client computer, and a server connected to at least one data source via a network. The server includes a hyperlink list generating module, an integrated link extracting module, a hyperlink checking module, and a filtering module.

The hyperlink list generating module configured for generating Web page connection commands according to a search string transmitted from the client computers, and generating integrated link extracting module configured for generating integrated link extraction commands, and extracting integrated link hyperlink list by executing the integrated link extraction commands; the hyperlink checking module configured for determining whether the extracted integrated links exist in a database according to titles of the extracted integrated links, and downloading Web pages of that integrated links which do not exist in the database; and the filtering module configured for determining whether there are any information irrelevant to the search string in the downloaded Web pages, and filtering out the irrelevant information.

Another preferred embodiment provides a method for searching and filtering Web pages is also disclosed. The method includes the steps of: generating Web page connection commands according to a search string transmitted from a client computer; generating a hyperlink list by executing the link commands; generating integrated links extraction commands; extracting integrated links related to the search string in each hyperlink in the hyperlink list by executing the extraction commands; determining whether the extracted integrated links exist in a database according to titles of the integrated links; deleting the integrated links if the extracted hyperlinks exist in the database; downloading Web pages of the integrated links that do not exist in the database; determining whether there are any information irrelevant to the search string in the downloaded Web pages; and filtering out the irrelevant information.

Other advantages and novel features of the embodiments will be drawn from the following detailed description with reference to the attached drawings.

### BRIEF DESCRIPTION OF THE DRAWINGS

FIG. 1 is a schematic diagram of a system for searching and filtering Web pages in accordance with the preferred embodiment;

FIG. 2 is a schematic diagram of function modules of the system of FIG. 1; and

FIG. 3 is flow chart of a preferred method for searching and filtering Web pages by implementing the system of FIG. 1.

### DETAILED DESCRIPTION OF THE INVENTION

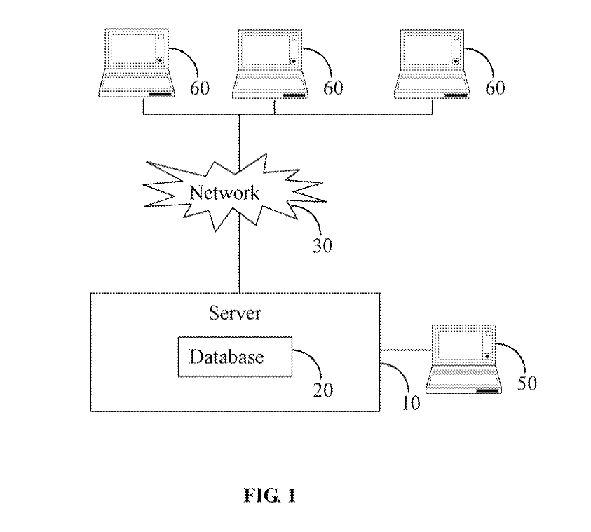

FIG. 1 is a schematic diagram of a system for searching and filtering Web pages (hereinafter, “the system”) in accordance with the preferred embodiment. The system includes a server 10 and at least one client computer 50 (only one shown) connected to the server 10. A network 30 connects the server 10 to a variety of data sources 60. The network 30 may be an intranet, the Internet, or any other suitable electronic communications network. The server 10 is configured for downloading Web pages from the variety of data sources 60 according to search strings transmitted from the at least one client computer 50, and for filtering out irrelevant content that are not related to the search strings from the Web pages. The irrelevant content may be advertisements and other irrelevant information. The search strings may include a plurality of keywords related to searched information inputted via the at least one client computer 50. The server 10 includes a database 20 configured for storing relevant Web pages and their respective hyperlinks related to the search strings. The relevant Web pages may consist of plain texts and related pictures.

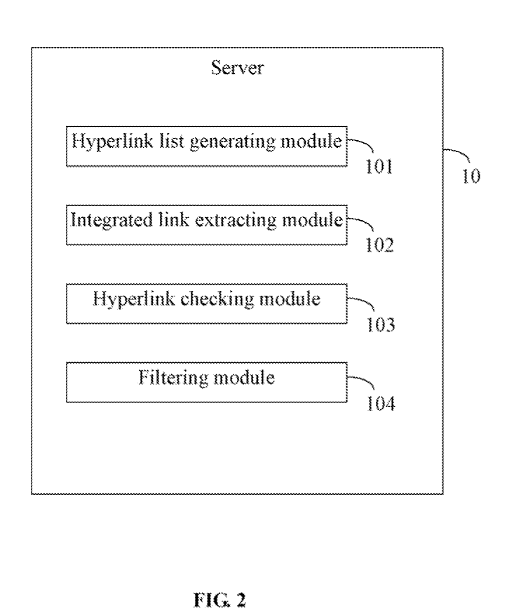

FIG. 2 is a schematic diagram of function modules of the server 10 of FIG. 1. The server 10 includes a hyperlink list generating module 101, a integrated link extracting module 102, a hyperlink checking module 103, and a filtering module 104.

The hyperlink list generating module 101 is configured for generating Web page connection commands according to a search string, and for generating a hyperlink list by executing the connection commands. The connection commands may be in an extensible markup language (XML) format, or any other suitable formats. The hyperlink list includes at least one hyperlink. When a hyperlink in the hyperlink list is selected and/or double clicked, a web page that may contain a plurality of integrated links appears before the user. An integrated link may be either of an embedded link, an inline link, or any other kinds of links integrated within the Web page.

The integrated link extracting module 102 is configured for generating integrated link extraction commands, and for extracting integrated links related to the search string in each hyperlink in the hyperlink list by executing the extraction commands. The extraction commands may also be in the XML format.

The hyperlink checking module 103 is configured for detecting whether each one of the extracted integrated links exists in the database 20 according to a title of the integrated link, deleting the extracted integrated links that already exist in the database 20, and for downloading the Web pages of the extracted integrated links that do not exist in the database 20.

The filtering module 104 is configured for determining whether there are any irrelevant information to the search string in the downloaded Web pages, filtering out the information which are irrelevant to the search string, and for storing the related Web page which may include plain texts and pictures in the database 20. The irrelevant information may be, for example, advertisements, menus or any other irrelevant data.

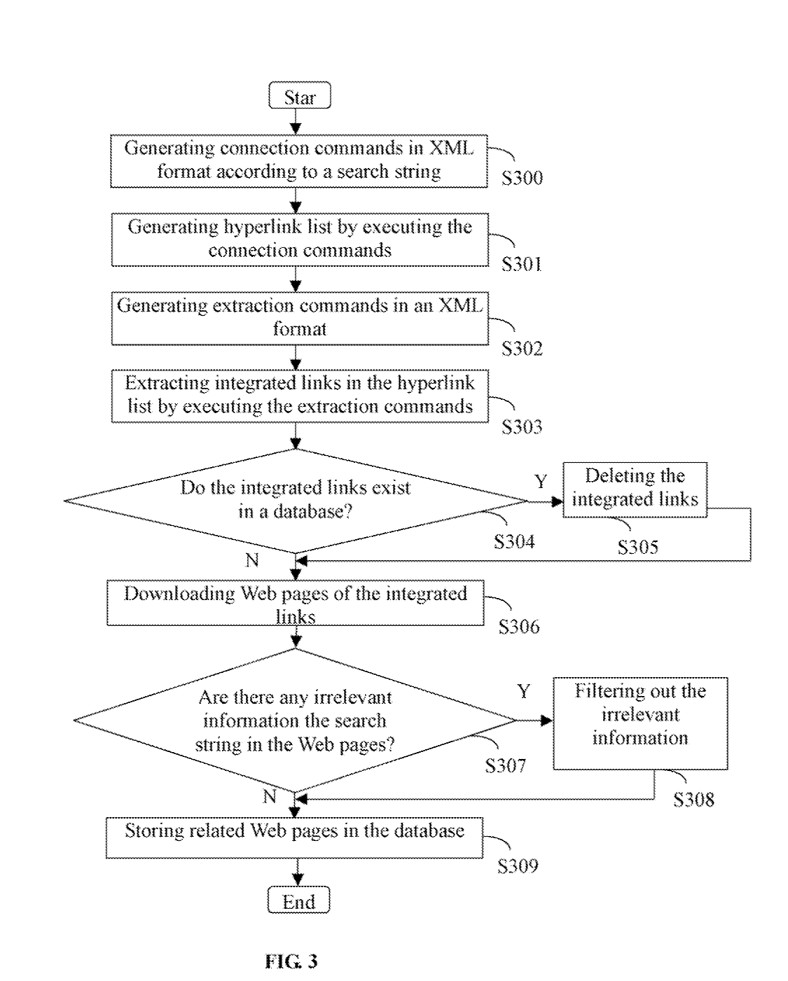

FIG. 3 is a flow chart of a preferred method for searching and filtering the Web pages by implementing the system as described above. In step S300, when the server 10 receives the search string containing a plurality of keywords transmitted from one of the client computers 50, the hyperlink list generating module 101 generates Web page connection commands according to the transmitted search string.

In step S301, the hyperlink list generating module 101 generates the hyperlink list by executing the connection commands. The connection commands may be in an XML format or any other suitable formats. The search string consists of the plurality of keywords corresponding to desired information. The hyperlink list includes at least one hyperlink. When a user selects or double clicks a hyperlink in the hyperlink list, a web page that may contain a plurality of integrated links appears before the user.

In step S302, The integrated link extracting module 102 generates integrated links extraction commands for extracting integrated links related to the search strings. The extraction commands may also be in the XML format.

In step S303, the integrated link extracting module 102 extracts integrated links related to the search string in each hyperlink in the hyperlink list by executing the extraction commands.

In step S304, The hyperlink checking module 103 determines whether each one of the extracted integrated links exists in the database 20 according to a title of the integrated link.

In step S305, if there are some integrated links existing in the database 20, the hyperlink checking module 103 deletes the extracted integrated links that already exist in the database 20.

Otherwise, if there are not any integrated links existing in the database 20, in step S306, the hyperlink checking module 103 downloads Web pages of the extracted integrated links that do not exist in the database 20.

In step S307, the filtering module 104 determines whether there are any irrelevant information in the downloaded Web pages.

In step S308, the filtering module 104 filters out the information which are irrelevant to the search string. The irrelevant information may be, for example, advertisements, menus or any other irrelevant data.

Otherwise, if the information of the Web pages are related to the search string, in step S309, the filtering module 104 stores the related information which may include plain texts and pictures in the database 20.

It should be emphasized that the above-described embodiments, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure, and the present invention is protected by the following claims.

What is claimed is:

1. A system for searching and filtering Web pages, comprising at least one client computer and a server connected to a network, the server comprising:
a hyperlink list generating module configured for generating Web page connection commands according to a search string transmitted from the client computers, and generating hyperlink list by executing the Web page connection commands;
an integrated link extracting module configured for generating integrated link extraction commands, and extracting integrated links related to the search string in each hyperlink in the hyperlink list by executing the integrated link extraction commands;
a hyperlink checking module configured for determining whether the extracted integrated links exist in a database according to titles of the extracted integrated links, and downloading Web pages of the extracted integrated links which do not exist in the database; and
a filtering module configured for determining whether there are any information irrelevant to the search string in the downloaded Web pages, and filtering out the irrelevant information.

2. The system according to claim 1, wherein the hyperlink checking module is further configured for deleting the extracted integrated links that already exist in the database.

3. The system according to claim 1, wherein the filtering module is further configured for storing the Web page related to the search string.

4. The system according to claim 1, wherein the irrelevant information are selected from the group consisting of advertisements, menus and any other irrelevant contents.

5. The system according to claim 1, wherein the connection commands is in an extensible markup language format.

6. An enabled-computerized method for searching and filtering Web pages, the method comprising the steps of:
generating Web page connection commands according to a search string transmitted from a client computer;
generating a hyperlink list by executing the Web page connection commands;
generating integrated links extraction commands;
extracting integrated links related to the search string in each hyperlink in the hyperlink list by executing the integrated links extraction commands;
determining whether the extracted integrated links exist in a database according to titles of the extracted integrated links;
deleting the integrated links if the extracted hyperlinks exist in the database;
downloading Web pages of the integrated links that do not exist in the database;
determining whether there are any information irrelevant to the search string in the downloaded Web pages; and
filtering out the irrelevant information.

7. The method according to claim 6, further comprising the steps of:
storing the Web page related to the search string in the database.

8. The method according to claim 6, wherein the connection commands is in an XML format.

9. The method according to claim 6, wherein the irrelevant information are selected from the group consisting of advertisements, menus or any other irrelevant contents.
